(19) United States
(12) Patent Application Publication
(10) Pub. No.: US 2012/0231206 A1
(43) Pub. Date: Sep. 13, 2012

(54) LOOP MATERIAL FOR HOOK AND LOOP FASTENERS

(75) Inventors: Delton R. Thompson, JR., Lake Elmo, MN (US); Robert T. Cesena, Hudson, WI (US); Timothy J. Diekmann, Maplewood, MN (US)

(73) Assignee: 3M Innovative Properties Company

(21) Appl. No.: 13/044,019

(22) Filed: Mar. 9, 2011

(51) Int. Cl. D04H 11/00; B32B 37/12; B32B 38/00; B32B 37/02

(52) U.S. Cl. 428/94; 156/72

(57) ABSTRACT

Presently described are loop materials comprising continuous multi-filament textured yarns intermittently bonded to a backing. In one embodiment, the yarn has a denier of less than 50, an energy at break of at least 60 joules/g, and an elongation of less than 45%. The multi-filament textured yarns preferably have a basis weight of no greater than 10 gsm and in some embodiments no greater than 5 gsm. In another embodiment, the loop material has a basis weight of no greater than 5 gsm and is characterized by having a ratio of shear strength to yarn basis weight of at least 300 g(f)/(g/m²). Such loop material preferably comprises a yarn having a denier of less than 50.

### BACKGROUND

Hook and loop type mechanical fasteners are known. Typically the loop portion of the mechanical fastener comprises a backing having a multiplicity of upstanding loops projecting from its surface. These upstanding loops engage with the hooks on the hook portion of the mechanical fastener.

Loop materials are commonly made by weaving or knitting yarn or fibrous loops in a fabric-like woven backing, or by stitching loops into a fabric or film backing.

Alternatively, loop materials have also been made by intermittently bonding spaced yarns or sheets of fibers to a backing such as described for example in EP 0341993, U.S. Pat. No. 5,611,791 and U.S. Pat. No. 5,830,298.

While known loop materials work well with many hook fastener materials, such materials can be relatively expensive, especially when the loop material is intended to be used for only a limited time such as in the case of disposable diapers and other disposable articles. Accordingly, industry would find advantage with loop materials and methods of making loop materials that are amenable to reducing cost.

### BRIEF DESCRIPTION OF THE DRAWINGS

FIG. 1 is schematic representation of one embodied method of making loop material.

FIG. 2 is a top plan view photomicrograph of one illustrative loop material.

FIG. 3 is a perspective view photomicrograph of the hook material utilized to evaluate the peel force and shear strength.

FIG. 4 is a plan view photomicrograph of the hook material of FIG. 3.

### SUMMARY OF THE INVENTION

In one embodiment, a loop material is described continuous multi-filament textured yarns intermittently bonded to a backing. The yarn has a denier of less than 50, an energy at break of at least 60 joules/g, and an elongation of less than 45%. In favored embodiments, the multi-filament textured yarns have a basis weight of no greater than 10 gsm and in some embodiments no greater than 5 gsm.

In another embodiment, a loop material is described comprising continuous multi-filament (e.g. textured) yarns intermittently bonded to a backing wherein the loop material has a basis weight of no greater than 5 gsm. The loop material is characterized by having a ratio of shear strength (as determined by ASTM D5169-98) to yarn basis weight of at least 300 g(f)/(g/m²). Such loop material preferably comprises a yarn having a denier of less than 50.

In another embodiment, a method of making a sheet of loop material is described comprising providing a plurality individual multi-filament textured yarns wherein the yarn has a denier of less than 50, an energy at break of at least 60 joules/g, and an elongation of less than 45%; corrugating the yarns; and securing the corrugated yarns to a backing material. The corrugated yarns are typically secured by intermittently bonding the yarns to a thermoplastic backing material. In one embodiment, the corrugated yarns are secured by extrusion of the thermoplastic backing material. In favored embodiments, intermittently bonded multi-filament textured yarns have a basis weight of no greater than 10 gsm and in some embodiments no greater than 5 gsm.

In each of the embodiments described herein, the loop material or method may be further characterized by any one or any combination of various features as described in the forthcoming detailed description and examples. For example, in each of these embodiments, the yarn may have a denier of no greater than 45. Further, the filaments of the yarn have a denier of less than 5. The backing may comprise a thermoplastic polymer, such as a polypropylene copolymer. The multi-filament (e.g. textured) yarns may comprise nylon filaments. The yarns are typically spaced at a distance no greater than 5 mm.

Further, in the various embodiments described herein, the loop material may consist of one type of multi-filament (e.g. textured) yarns or comprise a first multi-filament (e.g. textured) yarns in combination with at least one second yarn that differs from the first yarn. The second yarn typically has an energy at break of at least 60 joules and an elongation of less than 45%. The second yarn may have a denier of 50 or greater and/or comprise a different polymer having a melt point no greater than 160° C.

### DETAILED DESCRIPTION

Presently described is a loop material comprising a backing intermittently bonded to continuous multi-filament textured yarns. The intermittently bonded multi-filament textured yarns provide portions bonded to the backing along a front surface at spaced bonding locations that form arcuate portions of the yarns projecting from the front surface of the backing between the bonding locations.

The arcuate portions have a height from the backing of less than about ¼ inch (0.64 centimeters) and preferably less than about ⅛ inch (0.318 centimeters). The width (w1) of the bonding locations 200 typically ranges from about 0.5 mm (0.02 inches) and to about 2 mm (0.079 inches). In some favored embodiments, the width (w2) of the arcuate portions 100 of the yarns ranges from about 1 mm (0.04 inches) to 5 mm (0.20 inches).

The yarns of the arcuate portions may project to a height that ranges from at least one third, or one half up to 1.5 times the distance between the bonding locations. In some embodiments, the yarns of the arcuate portions project to about the same height above the front surface as the distance between the bonding locations.

The arcuate portions are formed from a plurality of multi-filament yarns, such as twisted yarns or core and effect yarns, such as disclosed in U.S. Pat. Nos. 5,447,590 and 5,379,501. The twisted yarns typically have a relatively low number of twists per unit length of the yarn. With continuous mulit-filament yarns, the number of twists can be as low as feasible and still produce a handleable yarn. Generally, this is as low as 5 twists per meter but the number of twists can range from 5 to 5,000 twists per meter, preferably 10 to 1,000 twists per meter. The upper limit on twists per unit length may be higher provided that the yarns are not twisted so tightly, the yarn will not transversely separate into filaments under moderate force and thus not perform as a loop fastening material.

The multi-filament yarns are textured as known in the art. (See for example, Yarn Texturing Technology, J. W. S. Hearle, L. Hollick, and D. K. Wilson, Woodhead Publishing Ltd and CRC Press LLC, 2001

Reducing the basis weight of loop materials has been constrained at least in part by material handling concerns. For example, when a loop material is formed from a sheet of fibers (e.g. a nonwoven web), the basis weight of the sheet of fibers needs to be sufficient to form a viable web of sufficient strength to be conveyed by processing equipment used to form the loop material. Nonwoven webs of less than 15 gsm typically cannot be wound and subsequently unwound due to lack of uniformity and/or sufficient strength that can result in tearing during processing.

One approach to reduce the basis weight of a loop material is the utilization of low denier yarns. In favored embodiments, the arcuate portions are formed from a plurality of continuous multi-filament textured yarns, each yarn having a denier of no greater than 50. Each yarn has a plurality of filaments. The denier of the filaments of the yarn is typically no greater than 10, 9, 8, 7, 6, and in favored embodiments no greater than 5. The denier of the filament of the yarns is typically at least 0.5, or 1, or 2. Hence, the number of filaments per yarn is at least 5 or 10 and preferably 15, 20, or 25 to 100.

The multi-filament textured yarns collectively have a basis weight of less than 10 gsm, 9 gsm, 8 gsm, 7 gsm, 6 gsm, or no greater than 5 gsm. The basis weight of the multi-filament textured yarns is typically at least 1 gsm, 1.1. gsm, 1.2 gsm, 1.3 gsm, 1.4 gsm or 1.5 gsm. The basis weight of the yarn can be determined by measuring the basis weight of the entire loop material and subtracting the basis weight of the backing.

It is appreciated that various physical properties of a multi-filament yarn are related to the denier of the yarn, the denier of the filaments, as well as the material of the filaments. Various thermoplastic materials have been described as being suitable for making loop materials provided that the yarn denier is relatively high. However, at smaller and smaller yarn deniers, such materials may no longer be suitable. For example, when a majority of the filaments are formed from polypropylene or polyethylene and even some types of polyester and the yarn has a denier of no greater than 50, the yarns typically do not have the proper physical properties for processing the yarns into loop material as described herein.

It has been found that when the yarn has an energy at break (as measured according to ASTM D3759-91) of 55 J/g or less, the yarns break and thus cannot be processed into loop material as described herein. Hence, the multi-filament yarn of the loop materials described herein has an energy at break of at least 60 J/g, 65 J/g, 70 J/g, or 75 J/g. Although at least a portion of the yarns could have a higher energy at break, the majority of the yarns typically have an energy at break no greater than 150 J/g, 140 J/g, or 130 J/g and in some embodiments no greater than 125 J/g, 115 J/g, or 100J/g.

It has also been found that when the yarn has an elongation greater than about 50% (as also measured according to ASTM D3759-91) the yarn also cannot be processed into loop materials as described herein because the yarns cannot be successfully corrugated. Hence, the multi-filament yarn of the loop materials described herein have an elongation no greater than about 45%, or 40%, or 35%, or 30%. The elongation is typically at least 10%, 15%, or 20%.

Preferred yarns can also be characterized as having a yarn tenacity of at least about 3.5 or 4 grams force/denier. In some embodiments the yarn tenacity is at least 4.5, or 5, or 5.6, or about 6 grams force/denier.

Filament forming materials that exhibit the energy at break, elongation and tenacity, just described include such certain polyesters and polyamides. In particular, nylon is a preferred polyamide filament forming material of the multi-filament yarns.

In some embodiments, the filaments forming the multi-filament yarns further comprise a thermoplastic material that softens or melts at temperatures no greater than about 160° C., and in some embodiments no greater than 150° C., or 140° C., or 130° C. For example, the filaments of the yarn may have a sheath/core construction. In sheath/core binder fibers, the outer layer of the filament would be formed of a lower melting point material such as a polyolefin. The core could be formed of a higher melting point material such as nylon and the like. The inclusion of lower softening or melting point filaments in the multifilament yarn can enhance engagement of the yarn to an extruded film backing.

In some embodiments, the entire loop material is formed from multi-filament (e.g. textured) yarns having a denier of no greater than 50. In this embodiment, the loop material is free of yarns having a denier greater than 50.

In other embodiments, the loop material is formed from at least two different multi-filament (e.g. textured) yarns, the first having a denier of no greater than 50, and the second yarn differing in denier, filament composition, etc. When the loop material is prepared by corrugating the yarns as described herein, the second yarn has suitable yarn properties (e.g. at break, elongation and tenacity) as previously described.

In some embodiments, the second yarn is a multi-filament (e.g. textured) yarn having a denier greater than 50. Alternatively or in combination with having a higher denier, the second yarn may comprise filaments of a different thermoplastic polymer than the first yarn. For example, higher denier thermoplastic yarns such as polypropylene yarns may be used in combination with the lower denier (e.g. nylon) yarns. The inclusion of the polypropylene yarns can improve the softness or “hand” of the loop material.

The denier or the second yarn may be at least 55, or 60 or 75. In some embodiments, the second yarn may have a denier of at least 100, or 125, or 150. Although replacing a single high denier yarn with a low denier yarn as described herein (e.g. 5% of the total loop material) will reduce the basis weight to some extent, the reduction in basis weight increases as the inclusion of lower denier yarns increases. Thus in some embodiments, at least 10%, 20%, 30%, 40%, 50%, 60%, 70%, 80%, or 90% of the yarns of the loop material have a denier or less than 50. In some favored embodiments, no greater than 50%, 45%, 40%, 35%, 30%, or 25% of the loop material is comprised of yarns having a denier of greater than 50.

The continuous yarns are generally intermittently bonded such that parallel adjacent yarns are spaced at a distance no greater than about 5 mm, 4 mm, 3 mm, 2 mm, or 1.5 mm. The spacing is greater than 0 and in some embodiments at least 0.5 mm. Depending on the denier of the yarn, the number of yarns per inch is typically at least 5, 6, or 7 and no greater than about 50, or 40, or 30. In some embodiments, the number of yarns per inch is no greater than 25 or 20.

The continuous multi-filament textured yarns are intermittently bonded to the backing such that there is sufficient open area between the yarns along the arcuate portions to afford ready engagement of the fibers along the arcuate portions by the hook portion of the fastener. Such open area ranges from about 10 to 70 percent of the arcuate portions.

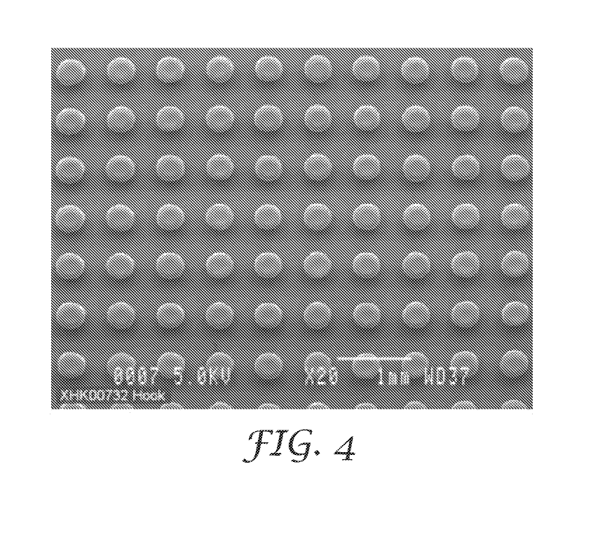

The loop materials described herein have been found to exhibit good hook engagement properties, as determined by the test method described in the forthcoming examples using a hook available from 3M Company, St. Paul, Minn. under the trade designation “CHK 00732”. A photomicrograph of this particular hook is depicted in FIGS. 3-4. This hook material may be described as a mushroom-style hook having 1600 hooks per square inch, a hook height of about 440 microns, a cap diameter of about 340-350 microns, and a cap thickness of 60 microns. The following table depicts typical and preferred peel force and shear strength values of embodied loop materials reported in grams force (i.e. g(f)).

Table of Peel Force and Shear Strength
of Embodied Loop Material

| | Preferred | Typical |
|---|---|---|
| | Properties g(f) | Properties g(f) |
| Peel Force Test Method 1 | At least 150 or 200 | At least 100 |
| Max. Load | | |
| Peel Force Test Method 1 | At least 50 | At least 25 |
| Avg. Load | | |
| Peel Force Test Method 1 | At least 60, 80, or 100 | At least 40 |
| Avg. Peak Load | | |
| Peel Force Test Method 2 | At least 350, or 400 | At least 300 |
| Max. Load | | |
| Peel Force Test Method 2 | At least 100 | At least 75 |
| Avg. Load | | |
| Peel Force Test Method 2 | At least 150, or 200 | At least 125 |
| Avg. Peak Load | | |
| Shear Strength | At least 1500, 2000, | At least 1000 |
| ASTM D5169-98 | or 2500 | |
| Max. Load | | |

Surprisingly sufficient peel and shear values were obtained in spite of having a low basis weight. Hence, there is not a linear relationship between basis weight and peel and shear properties. Further, it has been found that conventional loop materials typically include excessive basis weight relative to the amount of loop material actually required for good hook engagement. One way to express this characteristic is peel force or shear strength/per basis weight of yarn. This is determined by dividing the peel force or shear strength values by the basis weight of the yarn to obtain a ratio. The following table depicts typical and preferred ratios of peel force or shear strength per basis weight of yarn material reported in grams force per gram per square meter (i.e. g(f)/(g/m²)).

Ratio of Peel Force or Shear Strength per Basis Weight of Yarn

| | Preferred Properties | Typical Properties |
|---|---|---|
| | g(f)/(g/m²) | g(f)/(g/m²) |
| Peel Force Test Method 1 | At least 40 | At least 20 |
| Max. Load | | |
| Peel Force Test Method 1 | At least 15 | At least 10 |
| Avg. Load | | |
| Peel Force Test Method 1 | At least 20 | At least 10 |
| Avg. Peak Load | | |
| Peel Force Test Method 2 | At least 100, 150, or 200 | At least 50 |
| Max. Load | | |
| Peel Force Test Method 2 | At least 20, 40, or 60 | At least 10 |
| Avg. Load | | |
| Peel Force Test Method 2 | At least 30, 50, or 70 | At least 15 |
| Avg. Peak Load | | |
| Shear Strength | At least 400, 600, or 800 | At least 275 |
| ASTM D5169-98 | | |
| Max. Load | | |

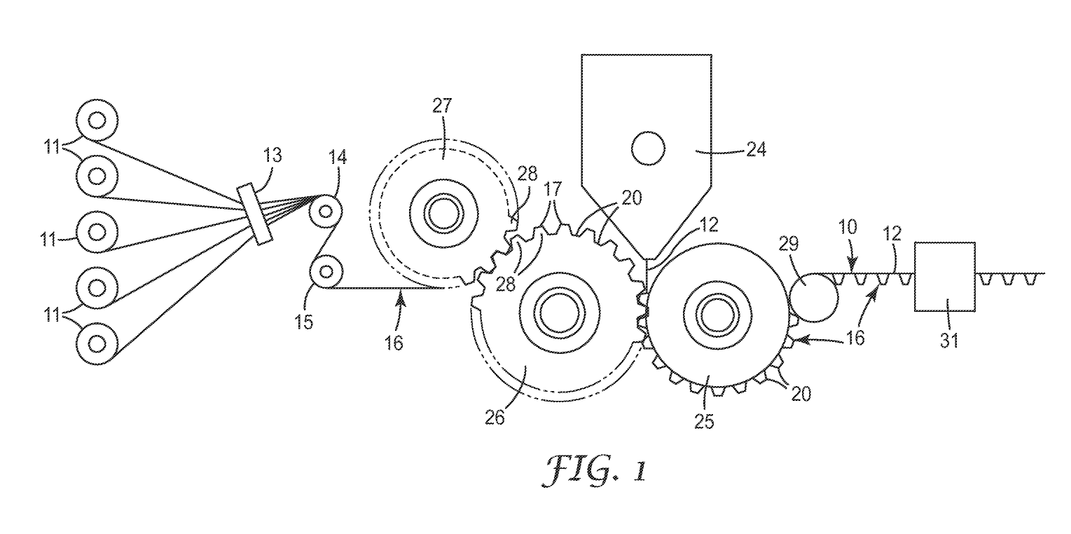

The continuous multi-filament textured yarns can be intermittently bonded to the backing using various techniques known in the art. In favored embodiments, the loop material is prepared by corrugating a plurality of continuous multi-filament textured yarns as described herein and securing the corrugated yarns to the backing material. The corrugated yarns may be secured by adhesively bonding the corrugated yarns to the backing or ultrasonically or thermally bonding corrugated yarns to the backing. In a favored embodiment, such as illustrated in FIG. 1, the corrugated yarns are secured by extrusion of a (e.g. molten) thermoplastic backing onto corrugated multi-filament textured yarns.

The backing of the loop material typically has a thickness ranging from 0.0025 to 0.005 centimeters. The thickness of the backing more typically ranges from 0.001 to 0.0015 to 0.002 inches. When the backing is adhesively bonded, the backing may be a woven, knitted, random woven, nonwoven or other layer of intertwined fibers. When the backing is ultrasonically or thermally bonded, the backing may comprises a single layer construction or have a multi-layer construction, such as described in EP 0341,993. When the backing is extruded, the backing is a continuous (e.g. single layer) thermoplastic film. Polyolefins, and in particular polypropylene, is a favored extrudeable backing material.

FIG. 1 schematically illustrates a favored method and equipment for forming loop material 10.

The method illustrated in FIG. 1 provides a plurality of continuous multi-filament textured yarns 16 such that it has arcuate portions 20 projecting in the same direction from spaced generally parallel anchor portions 17 and bonding the spaced generally parallel anchor portions 17 of the yarns 16 to a backing layer 12 with the arcuate portions 20 of the yarns 16 projecting from the front surface of the backing 12.

The arcuate portions 20 are generally provided by corrugating the spaced yarns and securing the corrugated yarns to the backing layer 12.

A plurality of individual yarns are provided on bobbins or packages 11 that are generally located on a creel. Likewise, the yarns are preferably supplied from a warp beam (not shown). The individual yarns can be fed from the creel of individual packages 11 into a comb 13, or like device, which uniformly spaces and distributes the yarns prior to being fed to a series of take-up or feed rolls 14 and 15 (optional). A further comb (not shown) can be supplied downstream of the rolls 14 and 15 to ensure that the yarns remain properly spaced, thereby providing spaced yarns 16, prior to being corrugated and bonded to the backing 12. Without intending to be bound by theory, corrugating the yarns allows the filaments to bulk to their preferred height. Further, corrugation reduces input line tension.

The spaced yarns 16 are conveyed to first and second heated corrugating members or rollers 26 and 27 each having an axis and including a plurality of circumferentially spaced generally axially extending ridges 28 around and defining its periphery, with the ridges 28 having outer surfaces and defining spaces between the ridges 28 adapted to receive portions of the ridges 28 of the other corrugating member 26 or 27 in meshing relationship with the spaced yarns 16 between the meshed ridges 28 and to afford rolling engagement between the ridges 28 and spaces of the corrugating members in the manner of gear teeth. The corrugating members 26 and 27 are mounted in axially parallel relationship with portions of the ridges 28 of the corrugating members 26 and 27 meshing generally in the manner of gear teeth; at least one of the corrugating members 26 or 27 is rotated; and the spaced yarns 16 fed between the meshed portions of the ridges 28 of the corrugating members 26 and 27 to generally conform the spaced yarns 16 to the periphery of the first corrugating member 26 and form the arcuate portions 20 of the spaced yarns 16 in the spaces between the ridges 28 of the first corrugating member 26 and the generally parallel anchor portions 17 of the spaced yarns 16 along the outer surfaces of the ridges 28 on the first corrugating member 26. The spaced yarns 16 are retained along the periphery of the first corrugating member 26 after it has moved past the meshed portions of the ridges 28. The thermoplastic backing layer 12 is formed and bonded to the anchor portions 17 of the spaced yarns 16 on the end surfaces of the ridges 28 on the first corrugating member 26 by extruding the thermoplastic backing layer 12 (e.g., polypropylene) in a molten state from a die 24 into a nip between the anchor portions 17 of the spaced yarns 16 on the periphery of the first corrugating member 26 and a cooling roll 25 after which a (continuous) web of loop material 10 is separated from the first corrugating member 26 and carried partially around the cooling roll 25 and through a nip between the cooling roller and a pinch roller 29 to complete cooling and solidification of the thermoplastic backing layer 12.

Preferably, the molten thermoplastic material forming backing film 12 has a suitable viscosity and the nip pressure is low enough such that the thermoplastic material envelopes and/or engages a plurality of the filaments of the yarn on one face thereof without substantially encapsulating the yarn(s) as a whole. Alternatively, the yarns may be encapsulated at the bonding regions.

The spaced yarns 16 fed between the meshed portions of the ridges 28 of the corrugating members 26 and 27 can be uniformly distributed across the width of the spaced yarns 16 and all extend generally perpendicular to the axes of the corrugating members 26 and 27. This is typically accomplished by evenly (i.e. uniformly) spacing the yarns in machine direction (e.g. by use of the comb). In some embodiments, the yarns are uniformly spaced at a distance of about 3 mm, about 4 mm, or 5 mm.

Corrugating members 26 and 27 adapted to have such spaced yarns 16 fed into them can have their ridges 28 oriented generally in the range of 0 to 45 degrees with respect to their axes, but preferably have their ridges 28 oriented at 0 degrees with respect to (or parallel to) their axes which simplifies making of the corrugating members 26 and 27.

The cooling roll 25 can be water cooled and have a chrome plated periphery which is particularly useful for forming the sheet of loop material 10 because of the high rate of heat transfer such a cooling roll 25 affords from the molten thermoplastic backing layer 12 into the cooling roll 25.

Preferably, the drives for the corrugating members 26 and 27 and for the cooling roller 25 are separately controllable so that the cooling roller 25 can be rotated at a surface speed that is the same as or different than the surface speed of the first corrugating member 26. When the cooling roller 25 and the first corrugating member 26 are rotated so that they have the same surface speed, the spaced yarns 16 will have about the same shape along the backing 12 as it had along the periphery of the first corrugating member 26. When the cooling roller 25 and the first corrugating member 26 are rotated so that the cooling roller 25 has a surface speed that is slower than the surface speed of the first corrugating member 26, (e.g., one quarter or one half) the anchor portions 17 of the sheet of fibers 16 will be moved closer together in the molten thermoplastic backing layer 12 at the nip between the cooling roller 25 and the first corrugating member 26, resulting in greater density of the loop portions 20 along the backing 12 than when the cooling roller 25 and the first corrugating member 26 are rotated so that they have the same surface speed. This technique of increasing the amount of loop portions 20 or the loop population on the sheet of loop material 10 is useful both to make sheets of loop materials 10 having different numbers of loop portions 20 per centimeter of backing length using the same equipment, and to make sheets of loop materials 40 with more loops portions 20 per centimeter of backing length than could be formed between ridges 28 machined on the corrugating members 26 and 27 because of physical limitations in machining such ridges 28 close together.

Optionally, the quenched backing 12 of the sheet of loop material 40 can be printed on its surface opposite the spaced yarns 16 through the use of a printer 31, either in the production line as illustrated, or as a separate operation.

If desired, an additional sheet or web can be incorporated on the face of the thermoplastic film 12 opposite that joined to the multi-filament yarns 16 such as a woven, knitted or other type of fibrous sheet or web or a second film layer. This added web substrate can be used to increase strength or improve the tactile feel or provide other performance or aesthetic qualities. This opposite face of film could also be provided with further multifilament yarns, as above, to provide a two sided loop fastening material. The transversely spaced corrugated yarns can optionally further be pattern bonded to a backing by ultrasonic bonding, heat and/or pressure bonding or adhesive bonding by conventional means. An added web substrate is typically not preferred as the inclusion of such adds material costs and additional processing.

The resulting loop fastening material 10 is suitable for forming into loop fasteners for engaging male mechanical fastening elements of conventional design. For example, the loop or filament engaging elements at the top of the male mechanical fastening elements can be of any conventional shape including a mushroom-style hook, a J-hook or a multi-directional hook. Generally when forming a mechanical closure system using the invention loop fasteners the overhanging portions of the fiber or filament engaging elements on the male mechanical fastening elements are fixed on one closure surface so that they are oriented in a direction substantially parallel to the direction of transverse orientation of the oriented backing substrate of the loop fastener. This orientation of the fiber engaging elements of the hooks and the loop fastener provides for maximum peel force for the resulting closure system.

The size and shape of the male mechanical fastening elements employed depends in part on the degree of openness and loft of the loop fastening material following orientation of the backing and the attached yarns. Preferably, the male mechanical fastening element fiber engaging element average overall height is less than the average height of the yarns on the loop fastener material, most preferably at least 1 to 50 percent of the average height of the arcuate multi-filament yarn material.

One suitable male mechanical fastening elements (i.e. hook) is available from 3M Company, St. Paul, Minn. under the trade designation “CHK 00732”. The following illustrative non-limiting examples of embodiments of loop materials were made according to the method described in U.S. Pat. No. 5,611,791 by corrugating multi-filament yarns.

### Example 1

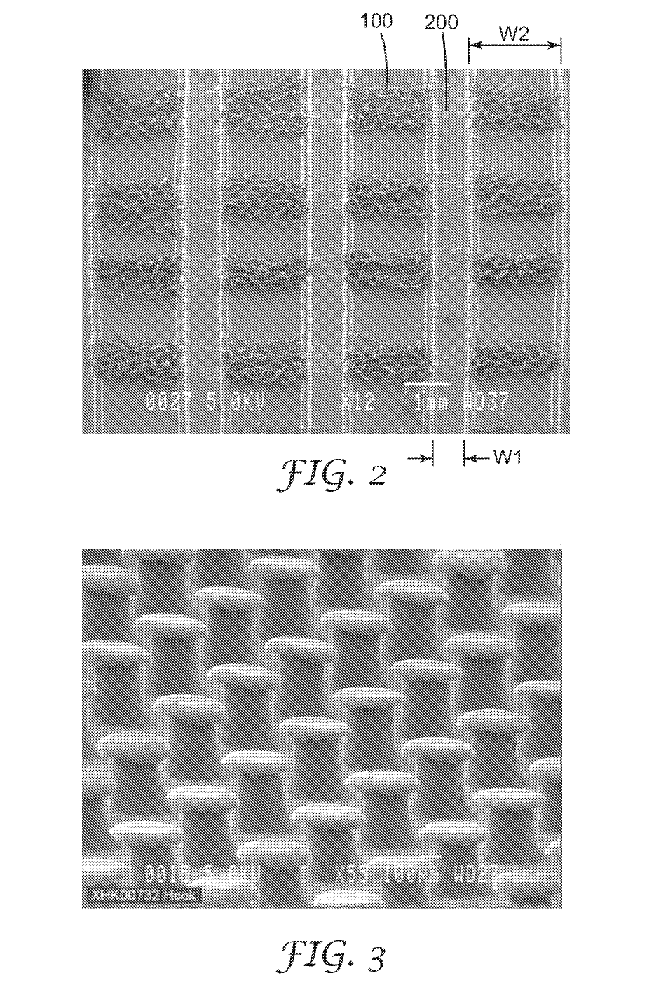

Multi-filament textured nylon yarn, available from Unifi Inc., Greensboro, N.C., under the trade designation “Unifi Nylstar Nylon 6,6 N3052751.Q2R.50-1/40/13 SD Str. Nylon” was unwound from 60 packages on a creel. The multifilament nylon yarn was a textured single ply, 40 denier, 13 filaments, 3.08 denier per filament material. The mechanical properties of a single strand of this yarn were measured using an Instron at 300 mm/min, a 25.4 cm jaw gap, with a preload of 40 grams at a rate of 500 g(f)/min. The yarn tenacity was measured to be 3.9 g(f)/d, an elongation to break of 39% and a toughness of 78 J/g. The yarns were uniformly spaced at 7 ends per inch using a comb. The spaced yarns were corrugated at 10 bonds per inch and laminated to polypropylene in an extrusion bonded lamination process with a corrugation factor of 1.4:1. The corrugation factor was a basis weight multiplier and accounts for the material consumed during corrugation and shrinkage. The 1.4 multiplier was determined by measuring the multifilament line speed entering the corrugation nip relative to the machine line (e.g. cooling roll or wind-up roll) speed. The basis weight of the corrugated multi-filament yarns was 1.71 grams per square meter (gsm). The polypropylene copolymer film back-coat used for extrusion bonding was obtained from Total Petrochemicals, Houston, Tex. under the trade designation “Total 5571”. The film basis weight was 61 gsm. The line speed was 25 feet per minute (fpm). The temperature set point for the corrugating rolls (26 and 27 of FIG. 2) was 275° F. The back-coat laminating anvil roll (25 of FIG. 1) was chilled. The anvil roll nip pressure to the corrugating roll was 200 pounds per lineal inch.

The composite basis weight (i.e. the backing together with the yarn loops) was about 63 gsm.

### Comparative Example A

The same procedure as described above was repeated, however the nip between the corrugating rolls was left open resulting in the yarn not being corrugated—the nip was open. While the sample was submitted for peel and shear testing, the loop material did not engage with the hook substrate, which is a test prerequisite. Therefore, test results are not available, reflecting exceptionally poor performance. This comparative example was viewed under a microscope. It was found that the multifilament yarns were bundled, dense, or tightly bound (lacking sufficient arcuate height) and thus constrained from hook engagement.

### Example 2

The same general procedure as described in Example 1 was repeated, with the exception that the multi-filament nylon yarns were uniformly spaced at 14 ends per inch using the comb. The basis weight of the corrugated multi-filament yarns was 3.4 grams per square meter (gsm). The bottom corrugating roll temperature was increased to 310° F. and the line speed was increased to 40 fpm. The extrusion back-coat polypropylene copolymer film basis weight was 36 gsm. The composite basis weight was about 39 gsm. A photomicrograph of a portion of the loop material produced is depicted in FIG. 2. The photomicrograph shows the bulked loop filaments 100 available for hook engagement, the vertical corrugation bond zones 200 which encapsulate the filaments for adhesion. As also evident from this photomicrograph, the loop material has a high degree of web uniformity.

### Example 3

The same procedure described in Example 2 was followed, except the bottom corrugation roll temperature was increased to a set point of 425° F.

### Example 4

The same procedure as Example 2 was repeated except that every other nylon yarn was replaced with a polypropylene yarn, available from Drake Extrusion, Martinsville, Va. under the trade designation “CMT 4442”. The yarn was a textured single ply, 150 denier, 72 filaments, 2.08 denier per filament material. The polypropylene yarn elongation to break was 29%, the tenacity was 5.7 g(f)/d with a toughness or energy at break of 111 J/g. Thus, the yarns were arranged in an alternating pattern of nylon yarn, polypropylene yarn, nylon yarn, polypropylene yarn, etc. at a combined density of 14 ends per inch. The resulting yarn basis weight was calculated to be 6.1 gsm. The total composite basis weight (including the backing) was about 38 gsm.

### Example 5

The same procedure as Example 4 was repeated except that the yarns were placed into the comb at a combined density of 28 ends per inch. The resulting yarn basis weight was calculated to be 12.2 gsm. The total composite basis weight was about 44 gsm.

### Comparative Example B

A warp knitted loop sample N29, available from Aplix, Charlotte, N.C. was tested for peel and shear performance as previously described. The Knitted looped material is backed and has a fibrous basis weight of about 20 gsm and a film basis weight of about 25 gsm.

### Test Method and Test Results

The peel and sheer performance of the materials prepared as examples were measured using three different test methods.

All testing was conducted at constant temperature (23° C.+/−2° C.) and 50%+/−5% relative humidity. All materials and equipment equilibrated at these conditions for a minimum of 24 hours prior to testing. A universal constant rate of extension tensile testing instrument equipped with a computer for data recording and the required load ranges was used (Series 4200, 4500, or 5500 available from Instron Engineering Corporation, Canton, Mass.). The instrument crosshead speed was set to 12 inches/min with a peel distance of at least 1.25 inches for all tests. A minimum of ten replicates of fresh materials were averaged for the reported data.

In Test Method 1 (TM-3731), the force required to peel the hook material from the loop material at a 135 degree peel angle was measured. The test jig in the Instron tensile tester was set at 135 degrees (stationary).

The finished hook element used for testing was CHK-00732 (available from 3M Company, St. Paul, Minn.). The finished hook sample was prepared as a ¾ inches cross Direction (CD) by 1 inch machine Direction (MD) strip with fastening tape used as the backing material. The hook was attached to one end of a 1 inch by 8 inch paper leader which was then placed in the upper jaw of the Instron instrument. The finished loop element was attached with double sided tape to a 2 inches by 5 inches by 1/16 inch steel plate. The hook sample was gently placed hook side down onto the corresponding loop face on the plate and secured with two cycles (one forward and one backward pass) of a 4.5 pound hand held roller. The materials were oriented so that the peel was conducted in the hook CD and the loop CD.

The plate was placed into the 135 degree stationary jig on the Instron instrument and the paper lead was attached to the upper jaw of the instrument allowing for a slight amount of slack. The initial jaw separation (gauge length) was set to at least 8 inches. The instrument was started and measurements were taken of the average load (g(f)), average peak load (g(f)), and maximum load (g(f)).

In Test Method 2 (TM-3740), the force required to peel the hook material from the loop material at a 180 degree peel angle with shear engagement was measured. The finished hook element used for testing was CHK-00732 (available from 3M Company, St. Paul, Minn.). The finished hook sample was prepared as a ½ inch cross direction (CD) by 1 inch machine direction (MD) strip with fastening tape used as the backing material. The hook was attached approximately in the center of a 1 inch by 8 inches paper leader. The leader was folded in half away from the hook, so as to apply a shear engagement with one end and a 180 degree peel with the other. The finished loop element was cut to at least 3 inch CD by 2 inches MD. The hook sample was gently placed hook side down onto the corresponding loop face and secured with one cycle (one forward and one backward pass) of a 4.5 pound hand held roller. The shear engagement was conducted by hanging a 500 g mass from the finished assembly for 10 seconds. The 180 degree peel end of the leader was attached to the lower jaw while the loop was attached, vertically aligned to the leader, in the upper jaw of the Instron instrument, allowing for a slight amount of slack. The materials were oriented so that the peel was conducted in the hook CD and the loop CD.

The initial jaw separation (gauge length) was set to 3 inches. The instrument was started and measurements were taken of the average load (g(f)), average peak load (g(f)), and maximum load (g(f)).

The shear strength of the hook and loop fasteners described in the examples was measured according to ASTM D5169-98.

The finished hook element used for testing was CHK-00732 (available from 3M Company, St. Paul, Minn.). The finished hook sample was prepared as a ½ inch Cross Direction (CD) by 1 inch Machine Direction (MD) strip attached to a 3 inches×1 inch leader of 898 filament tape (available from 3M Company, St. Paul, Minn.). An additional 3 inch×1 inch strip of filament tape was used to cover the exposed adhesive (any remainder was folded over the first strip).

The finished loop element was cut to 3 inch CD by 30 mm MD and backed with a 3 inch by 30 mm strip of 898 filament tape. The hook sample was gently placed hook side down onto the corresponding loop face and secured with five cycles (five forward and five backward passes) of an 11 pound hand held roller. The materials were oriented so that the peel was conducted in the hook CD and the loop CD. The hook leader was placed in the upper jaw while the loop was place in the lower jaw of the Instron instrument, allowing for a slight amount of slack.

The initial jaw separation (gauge length) was set to 3 inches. The instrument was started and measurements were taken of the maximum load (g(f)).

TABLE 1
Peel Force and Shear Strength of Exemplified Loop Materials g(f)

| | | | | | | Comp. |
|---|---|---|---|---|---|---|
| | Ex. 1 | Ex. 2 | Ex. 3 | Ex. 4 | Ex. 5 | Ex. B |
| Peel Force Test Method 1 | 108.7 | 104.7 | 202.4 | 147.0 | 291.2 | 239.0 |
| Max. Load | | | | | | |
| Peel Force Test Method 1 | 31.7 | 41.4 | 84.8 | 75.5 | 154.2 | 63.8 |
| Avg. Load | | | | | | |
| Peel Force Test Method 1 | 41.2 | 49.3 | 100.6 | 89.5 | 180.1 | 98.9 |
| Avg. Peak Load | | | | | | |
| Peel Force Test Method 2 | 378.3 | 474.8 | 420.1 | 379.9 | 387.9 | 346.3 |
| Max. Load | | | | | | |
| Peel Force Test Method 2 | 129.6 | 139.6 | 91.2 | 117.3 | 103.8 | 106.3 |
| Avg. Load | | | | | | |
| Peel Force Test Method 2 | 168.7 | 214.6 | 149.3 | 159.6 | 138.5 | 139.8 |
| Avg. Peak Load | | | | | | |
| Shear Strength | 1080.3 | 1629.0 | 2799.4 | 2011.5 | 2927.2 | 3603.6 |
| ASTM D169-98 | | | | | | |
| Max. Load | | | | | | |

TABLE 2
Peel Force or Shear Strength of Table 1 Divided
by Basis Weight of Yarn g(f)/(g/m²)

| | | | | | | Comp. |
|---|---|---|---|---|---|---|
| | Ex. 1 | Ex. 2 | Ex. 3 | Ex. 4 | Ex. 5 | Ex. B |
| Peel Force Test Method 1 | 63.6 | 30.8 | 59.5 | 24.1 | 23.9 | 11.9 |
| Max. Load | | | | | | |
| Peel Force Test Method 1 | 18.5 | 12.2 | 24.9 | 12.4 | 12.6 | 3.2 |
| Avg. Load | | | | | | |
| Peel Force Test Method 1 | 24.1 | 14.5 | 29.6 | 14.7 | 14.8 | 4.9 |
| Avg. Peak Load | | | | | | |
| Peel Force Test Method 2 | 221.2 | 139.6 | 123.5 | 62.3 | 31.8 | 17.3 |
| Max. Load | | | | | | |
| Peel Force Test Method 2 | 75.8 | 41.1 | 26.8 | 19.2 | 8.5 | 5.3 |
| Avg. Load | | | | | | |
| Peel Force Test Method 2 | 98.7 | 63.1 | 43.9 | 26.1 | 11.4 | 7.0 |
| Avg. Peak Load | | | | | | |
| Shear Strength | 631.8 | 479.1 | 823.2 | 329.8 | 239.9 | 180.2 |
| ASTM D5169-98 | | | | | | |
| Max. Load | | | | | | |

With reference to Table 1, the peel force and shear strength of Comparative Example B is quite comparable to Example 3, yet the fibrous basis weight is about 5.8× greater than the ultra low basis weight of Example 3. This represents an 83% reduction in basis weight to produce an effective diaper loop landing zone material. This is noteworthy, since higher basis weights correspond to higher cost.

What is claimed is:

1. A loop material comprising:
continuous multi-filament textured yarns intermittently bonded to a backing wherein the yarn has a denier of less than 50, an energy at break of at least 60 joules/g, and an elongation of less than 45%.

2. The loop material of claim 1 wherein the yarn has a denier of no greater than 45.

3. The loop material of claim 1 wherein the filaments of the yarn have a denier of less than 5.

4. The loop material of claim 1 wherein the multi-filament textured yarns collectively have a basis weight of no greater than 10 gsm.

5. The loop material of claim 1 wherein the multi-filament textured yarns collectively have a basis weight of no greater than 5 gsm.

6. The loop material of claim 1 wherein the backing comprises a thermoplastic polymer.

7. The loop material of claim 1 wherein the yarns comprise nylon filaments.

8. The loop material of claim 1 wherein the yarns are spaced at a distance no greater than 5 mm.

9. The loop material of claim 1 wherein the loop material comprises a first yarn according to claim 1 and a second yarn that differs from the first yarn.

10. The loop material of claim 9 wherein the second yarn has an energy at break of at least 60 joules/g and an elongation of less than 45%.

11. The loop material of claim 9 wherein the second yarn has a denier of 50 or greater.

12. The loop material of claim 9 wherein the second yarn comprises filaments of a different thermoplastic polymer than the first yarn.

13. A loop material comprising:
continuous multi-filament yarns intermittently bonded to a backing wherein the loop material has a basis weight of no greater than 5 gsm and
a ratio of shear strength to basis weight of at least 300 g(f)/(g/m²).

14. The loop material of claim 13 wherein the continuous multi-filament yarns are textured.

15. The loop material of claim 13 wherein the yarn has a denier of less than 50.

16. The loop material of claim 13 wherein the yarns comprise nylon filaments.

17. The loop material of claim 1 wherein the loop material further comprises a second yarn that differs from the first yarn.

18. A method of making a sheet of loop material comprising:
a) providing a plurality individual multi-filament textured yarns wherein the yarn has a denier of less than 50, an energy at break of at least 60 joules/g, and an elongation of less than 45%;
b) corrugating the yarns;
c) securing the corrugated yarns to a backing material.

19. The method of claim 18 wherein the corrugated yarns are secured by intermittently bonding the yarns to a thermoplastic backing material.

20. The method of claim 18 wherein the corrugated yarns are secured by extrusion of the thermoplastic backing material.
